(19) United States
(12) Patent Application Publication
(10) Pub. No.: US 2003/0227369 A1
(43) Pub. Date: Dec. 11, 2003

(54) Rotary sensor with high reliability in contact between terminals and electrodes

(75) Inventors: Kyuichiro Terui, Miyagi-ken (JP); Hirofumi Okumura, Miyagi-ken (JP); Moritoshi Nakamura, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/441,760

(22) Filed: May 19, 2003

(30) Foreign Application Priority Data
Jun. 7, 2002 (JP) 2002-167484

(51) Int. Cl. H01H 19/00; H01H 21/00

(52) U.S. Cl. 338/162; 200/6 R

(57) ABSTRACT

A rotary sensor with a prolonged service life ensures stable electrical conduction between an intermediate terminal and an electrode even if the components making up the rotary sensor repeatedly expand and contract due to high and low temperatures. In the rotary sensor, an output detection member is constructed of an insulating board having an electrode on its surface, a retaining portion being formed on the insulating board. The intermediate terminal is made of a metal material, and has a pair of mounting portions provided on both ends thereof and a first contact portion and a second contact portion provided between the pair of mounting portions. The intermediate terminal is secured to the retaining portion of the insulating board by the pair of mounting portions such that it sandwiches the insulating board lengthwise. The first contact portion is in resilient contact with the internal pin and the second contact portion is in resilient contact with the electrode.

### BACKGROUND OF THE INVENTION

1. Field of the Invention

The present invention relates to a rotary sensor and, more particularly, to a rotary sensor capable of performing highly accurate detection of a rotational angle or a rotational speed or the like transmitted from outside.

2. Description of the Related Art

A conventional rotary sensor will be described in conjunction with the accompanying drawings. FIG. 19 is a sectional view of the conventional rotary sensor, FIG. 20 is an enlarged sectional view of an essential section of a circuit member, an output terminal and an intermediate terminal for the conventional rotary sensor, and FIG. 21 is an enlarged perspective view showing the intermediate terminal for the conventional rotary sensor.

A conventional rotary sensor 21 is adapted to take out the rotational angle of a shaft 41 in terms of an electrical signal, as shown in FIG. 19. The rotary sensor 21 has a circuit member 22 having an electric circuit for converting the rotational angle into an electrical resistance value, an output terminal 23 for connecting the rotary sensor 21 with an external source, and an intermediate terminal 24 for electrically connecting the circuit member 22 with the output terminal 23.

The intermediate terminal 24 has a main body 25 for constituting a conducting portion, and a retaining portion 26 for locking onto the circuit member 22. As shown in FIG. 21, the main body 25 of the intermediate terminal 24 is formed of an elastic, deformable material, such as phosphor bronze, and constructed so that the elastic resetting force produced from its contraction establishes electrical conduction by pressure-contact with both an electrode 22a for drawing signals from the electrical circuit and the output terminal 23, as shown in FIG. 20. The retaining portion 26 is provided with a projection 26a to be inserted into an engaging hole 22a formed in the circuit member 22.

The projection 26a has a portion that penetrates the engaging hole 22a, and the penetrating portion has a locking hook 26b that elastically deforms, as shown in FIGS. 20 and 21. The locking hook 26b restores its original shape after penetrating the engaging hole 22a. As shown in FIG. 20, when the locking hook 26b restores its original shape, it abuts against the edge of the engaging hole 22a so as to prevent the projection 26a from slipping off. At this time, the projection 26a penetrates the engaging hole 22a with a predetermined gap or clearance.

A drawing electrode 22c is formed to be extremely thin on the circuit substrate 22b. The main body 25 of the intermediate terminal 24 has a planar surface 25a in contact with the thin electrode 22c.

More specifically, the intermediate terminal 24 is disposed to sandwich the circuit member 22 in the direction of its plate thickness with the locking hook 26b of the engaging portion 26 and the planar surface 25a.

In the conventional rotary sensor 21, a circuit substrate 22b having a resistor pattern surface and a rotor 28 having a slider 27 in slide contact with the resistor pattern surface are disposed to oppose each other in a housing 29.

The rotor 28 is coupled to a shaft 41 through the intermediary of a lever 42, so that the shaft 41 of the rotary sensor 21 rotates as a driving shaft of a throttle valve (not shown) rotates. The slider 27 slides on the resistors of the resistor pattern surface to change the resistance value between itself and the output terminal 23 on the basis of a rotational amount.

A cover 43 is disposed to cover one open end of the housing 29. Furthermore, the main body 25 of the intermediate terminal 24 has a projecting portion 25b at the portion to be in contact with the output terminal 23. The projecting portion 25b secures the contact with the output terminal 23.

The following will explain a case where the rotary sensor is used with a vehicle, such as a two-wheeled vehicle or a motorbike. The rotary sensor is disposed in the vicinity of a combustion chamber of a drive engine. Thus, when the drive engine is driven or started, the heat from the combustion chamber is transmitted to the rotary sensor, heating the rotary sensor to a considerably high temperature (e.g., about 100° C.).

If the vehicle is left outdoors during a coldest season in a cold area with its drive engine stopped, the rotary sensor may become considerably cold due to a cold ambient air (e.g., about −20° C.).

Therefore, the rotary sensor is required to guarantee a wide operating temperature range (e.g., from −40° C. to +150° C.).

The descriptions will now be given of the expansion and contraction of the configurations of mainly the circuit member 22, the output terminal 23, the intermediate terminal 24 that make up the rotary sensor 21, the expansion and contraction being caused by changes in the operating temperature of the conventional rotary sensor.

The amounts of expansion and contraction of the circuit member 22, the output terminal 23 and the intermediate terminal 24 differ because of different temperature expansion coefficients of their constituents in hot or cold environments.

Hence, the relative positional relationship between the circuit member 22 and the output terminal 23 in the direction of plate surfaces thereof may be disturbed by the expansion or contraction attributable to temperature changes in the constituents. This causes the projection 26a to incline with respect to the circuit member 22 in the engaging hole 22a since the engaging portion 26 of the intermediate terminal 24 penetrating the engaging hole 22a of the circuit member 22 is disposed with the predetermined clearance in the engaging hole 22a. The projection 26a inclines longitudinally or laterally, the supporting point being the point of the locking hook 26b at which the locking hook 26b is in contact with the circuit member 22. The inclination causes the planar surface 25a of the intermediate terminal 24 positioned on the opposite surface from the supporting point to slide on the electrode 22c.

As described above, in the conventional rotary sensor, the constituents of the rotary sensor repeatedly expand and contract in response to high and low temperatures. Each time the expansion or contraction occurs, the planar surface 25a of the intermediate terminal 24 slides on the thin electrode 22c. The repeated sliding movement of the planar surface 25a on the electrode 22c tends to wear the electrode 22c in some cases, leading to a problem of unstable electrical conduction between the intermediate terminal 24 and the electrode 22c.

### SUMMARY OF THE INVENTION

Accordingly, the present invention has been made with a view toward solving the problem described above, and it is an object of the invention to provide a rotary sensor capable of maintaining stable electrical connection for an extended period of time.

One aspect of the present invention provides a rotary sensor equipped with a housing, a lead-out terminal that is made integral with the housing and has an internal terminal and an external terminal, an output detection member accommodated in the housing, and an intermediate terminal for electrically connecting the lead-out terminal and the output detection member, wherein the output detection member is formed of an insulating board having an electrode on its surface, a retaining portion being formed on the insulating board, the intermediate terminal is formed of a single sheet of elastic metal constituent, and has a pair of mounting portions provided on both ends thereof and a first contact portion and a second contact portion provided between the pair of mounting portions, the intermediate terminal is secured to the retaining portion by the pair of mounting portions such that it sandwiches the insulating board in the direction of its surfaces, the output detection member with the intermediate terminal secured thereto is accommodated in the housing, and the first contact portion is in resilient contact with the internal terminal and the second contact portion is in resilient contact with the electrode.

With this arrangement, the intermediate terminal is secured by the pair of mounting portions clamping the insulating board in the lengthwise direction, so that the intermediate terminal is positioned to be stably disposed on the insulating board. Moreover, the rotary sensor has a wide guaranteed operating temperature range (high temperature), and even if the components making up the rotary sensor expand or contract at high or low temperatures, the second contact portion of the intermediate terminal remains in stable resilient contact with the electrode on the insulating board. This makes it possible to provide a rotary sensor capable of maintaining stable electrical connection between the second contact portion and the electrode for a long time.

Preferably, the intermediate terminal has an arcuate first contact portion provided at the center thereof and a pair of second contact portions provided on both sides of the first contact portion.

With this arrangement, the first contact portion and the second contact portions of the intermediate terminal are formed at laterally symmetrical positions, so that the intermediate terminal can be installed on an insulating board or a resistor board without the restrictions on the orientation of the intermediate terminal. This permits easy assembly.

Preferably, the retaining portion of the insulating board is a through hole, and the mounting portion of the intermediate terminal is locked in the through hole.

This arrangement allows a predetermined through hole to be formed in the insulating board or the resistor board, so that an inexpensive rotary sensor can be provided.

Preferably, a free end of the mounting portion of the intermediate terminal does not protrude outward beyond the surface opposing the surface on which the electrode of the insulating board has been provided.

This arrangement makes it possible to provide a rotary sensor that allows reliable insulation of the free end of the mounting portion of the intermediate terminal providing a current carrying portion.

Preferably, the output detection member detects a rotational angle.

This arrangement makes it possible to provide a rotary sensor that rotates in synchronization with the drive shaft of the throttle valve (not shown), permitting stable detection of the rotational angle of the drive shaft to be accomplished for a prolonged time.

Another aspect of the present invention provides a rotary sensor equipped with a housing, a lead-out terminal that is made integral with the housing and includes an internal terminal and an external terminal, an output detection member accommodated in the housing, and an intermediate terminal for electrically connecting the lead-out terminal and the output detection member, wherein the output detection member is formed of an insulating board having an electrode on its surface, the intermediate terminal is formed of a single sheet of elastic metal constituent, and has a first contact portion, a second contact portion, and a projection that is provided on the second contact portion and cuts into the electrode, the output detection member secured to the electrode by projections of the intermediate terminal is accommodated in the housing, and the first contact portion is in resilient contact with the internal terminal and the second contact portion is in resilient contact with the electrode.

According to this arrangement, the intermediate terminal is secured to the electrode by the projection, so that the intermediate terminal is positioned to be stably disposed on the insulating board. Moreover, the rotary sensor has a wide guaranteed operating temperature range (high temperature), and even if the components making up the rotary sensor expand or contract at high or low temperatures, the second contact portion of the intermediate terminal remains in stable resilient contact with the electrode on the insulating board. This makes it possible to provide a rotary sensor capable of maintaining stable electrical connection between the second contact portion and the electrode for a long time.

Preferably, the intermediate terminal has an arcuate first contact portion provided at the center thereof and a pair of second contact portions provided on both sides of the first contact portion, and at least one of the second contact portions is provided with a projection cutting into the electrode.

With this arrangement, the first contact portion and the second contact portions of the intermediate terminal are formed at laterally symmetrical positions, so that the intermediate terminal can be installed on an insulating board or a resistor board without the restrictions on the orientation of the intermediate terminal. This permits easy assembly.

### BRIEF DESCRIPTION OF THE DRAWINGS

FIG. 1 is a sectional view showing an embodiment of a rotary sensor in accordance with the present invention;

FIG. 2 is a top plan view showing the embodiment of the rotary sensor in accordance with the present invention;

FIG. 3 is a first assembly view showing the embodiment of the rotary sensor in accordance with the present invention;

FIG. 4 is a second assembly view showing the embodiment of the rotary sensor in accordance with the present invention;

FIG. 5 is an enlarged sectional view of an essential section showing embodiments of a rotor and a cover for the rotary sensor in accordance with the present invention;

FIG. 6 is a top plan view showing an embodiment of a resistor board for the rotary sensor in accordance with the present invention;

FIG. 7 is a top plan view showing embodiments of the resistor board and an intermediate terminal for the rotary sensor in accordance with the present invention;

FIG. 8 is an enlarged sectional view of an essential section showing the embodiments of the resistor board and an intermediate terminal for the rotary sensor in accordance with the present invention;

FIG. 9 is a perspective view showing an embodiment of the intermediate terminal for the rotary sensor in accordance with the present invention;

FIG. 10 is a top plan view showing the embodiment of the intermediate terminal for the rotary sensor in accordance with the present invention;

FIG. 11 is a side view showing the embodiment of the intermediate terminal for the rotary sensor in accordance with the present invention;

FIG. 12 is an enlarged sectional view of an essential section showing a second embodiment of the rotor and the cover for the rotary sensor in accordance with the present invention;

FIG. 13 is an enlarged sectional view of an essential section showing a third embodiment of the rotor and the cover for the rotary sensor in accordance with the present invention;

FIG. 14 is a sectional view of an essential section showing a second embodiment of the intermediate terminal for the rotary sensor in accordance with the present invention;

FIG. 15 is a sectional view of an essential section showing a third embodiment of the intermediate terminal for the rotary sensor in accordance with the present invention;

FIG. 16 is a perspective view showing a fourth embodiment of the intermediate terminal for the rotary sensor in accordance with the present invention;

FIG. 17 is a top plan view showing the fourth embodiment of the intermediate terminal for the rotary sensor in accordance with the present invention;

FIG. 18 is a front view showing the fourth embodiment of the intermediate terminal for the rotary sensor in accordance with the present invention;

FIG. 19 is a sectional view showing a conventional rotary sensor;

FIG. 20 is an enlarged sectional view showing a circuit member, an output terminal and an intermediate terminal for the conventional rotary sensor; and

FIG. 21 is an enlarged perspective view showing the intermediate terminal for the conventional rotary sensor.

### DESCRIPTION OF THE PREFERRED EMBODIMENTS

A rotary sensor in accordance with the present invention will now be described with reference to the accompanying drawings.

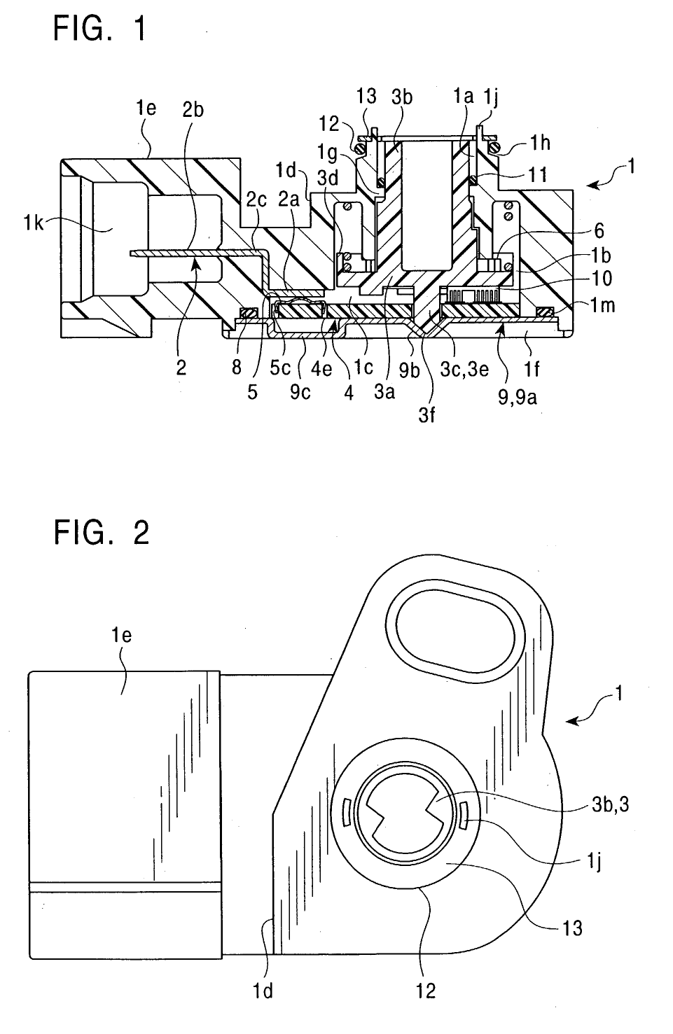

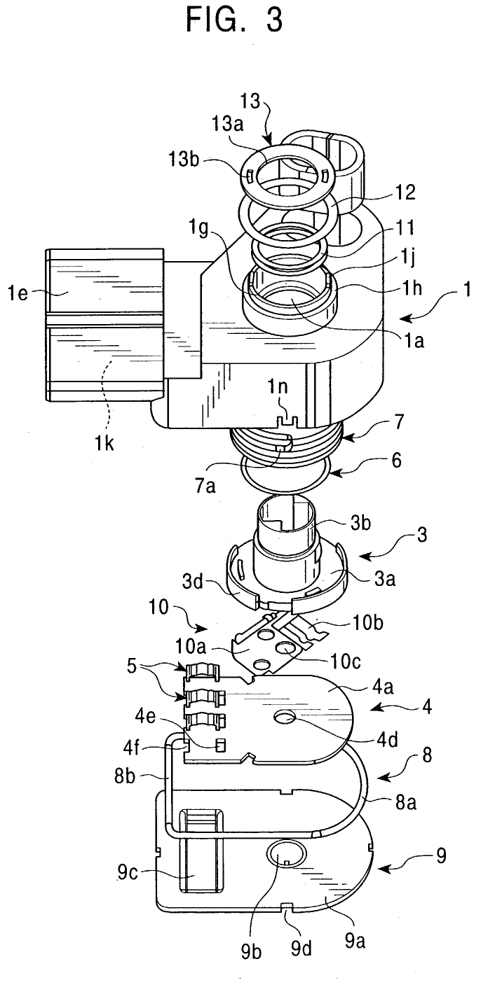

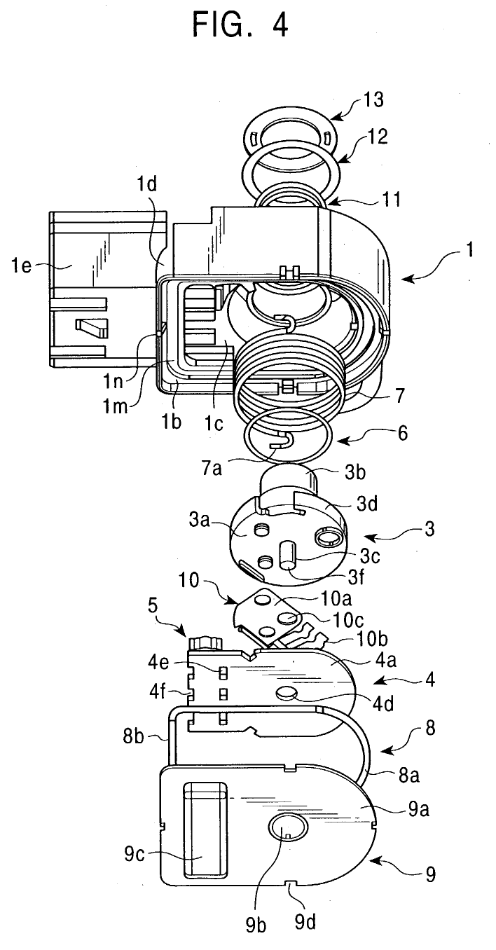

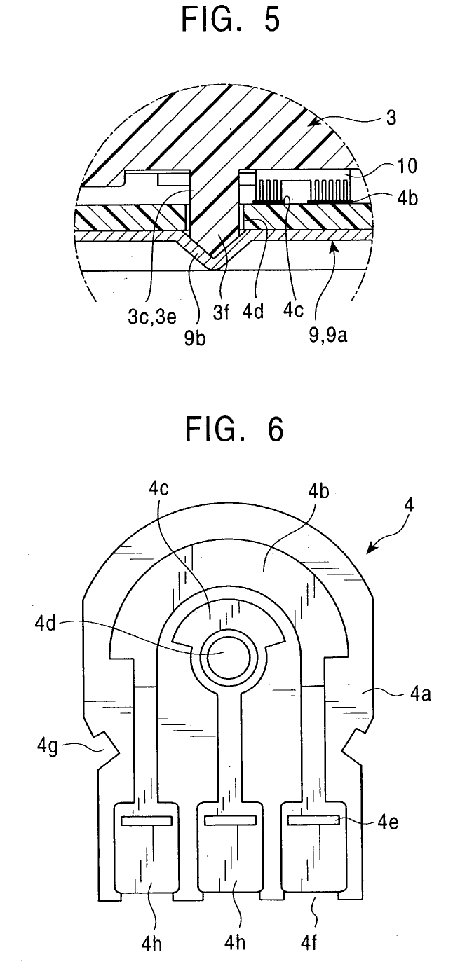

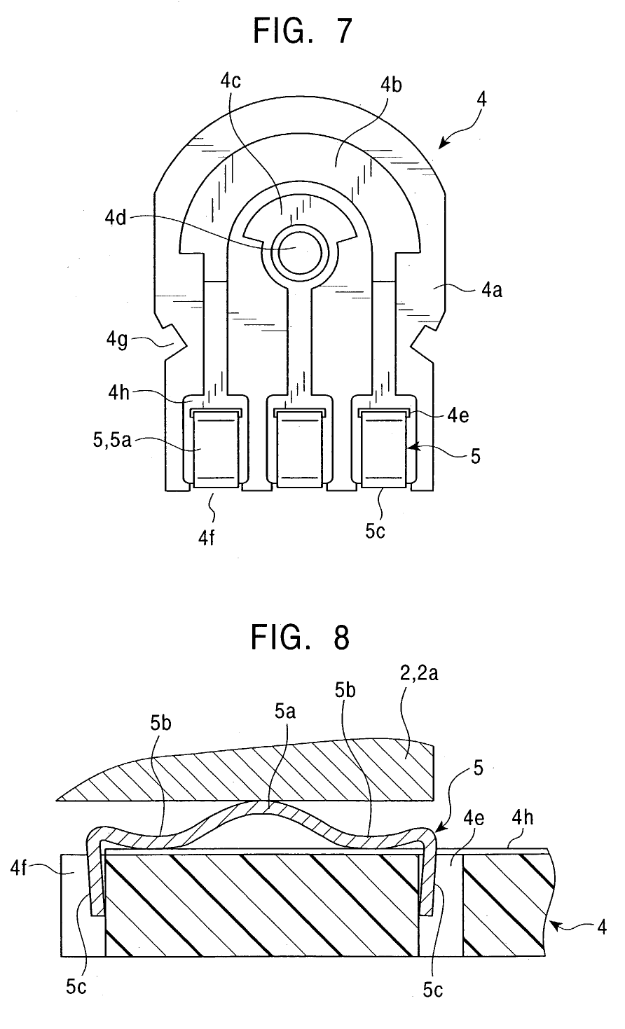

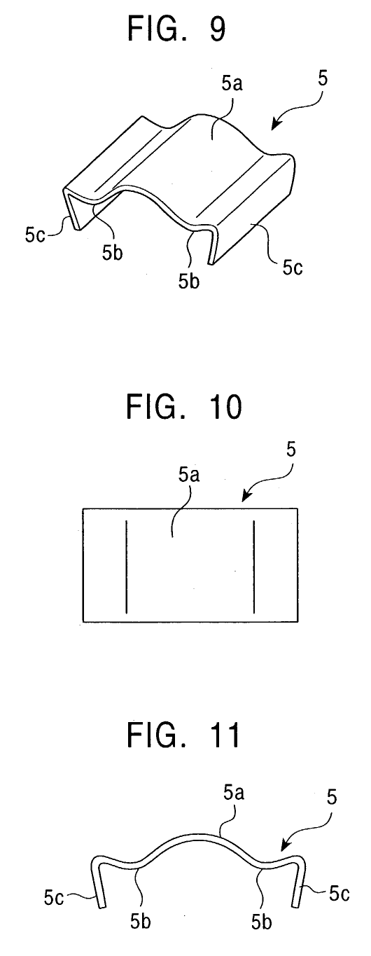

FIG. 1 is a sectional view showing an embodiment of a rotary sensor in accordance with the present invention; FIG. 2 is a top plan view showing the embodiment of the rotary sensor in accordance with the present invention; FIG. 3 is a first assembly view showing the embodiment of the rotary sensor in accordance with the present invention; FIG. 4 is a second assembly view showing the embodiment of the rotary sensor in accordance with the present invention; FIG. 5 is an enlarged sectional view of an essential section showing embodiments of a rotor and a cover for the rotary sensor in accordance with the present invention; FIG. 6 is a top plan view showing an embodiment of a resistor board for the rotary sensor in accordance with the present invention; FIG. 7 is a top plan view showing embodiments of the resistor board and an intermediate terminal for the rotary sensor in accordance with the present invention; FIG. 8 is an enlarged sectional view of an essential section showing the embodiments of the resistor board and an intermediate terminal for the rotary sensor in accordance with the present invention; FIG. 9 is a perspective view showing an embodiment of the intermediate terminal for the rotary sensor in accordance with the present invention; FIG. 10 is a top plan view showing the embodiment of the intermediate terminal for the rotary sensor in accordance with the present invention; and FIG. 11 is a side view showing the embodiment of the intermediate terminal for the rotary sensor in accordance with the present invention.

Referring to FIG. 1 through FIG. 4, the rotary sensor in accordance with the present invention is constructed of a rotor 3 having an engaging portion 3b with which a driving shaft (not shown) of a throttle shaft of a vehicle is engaged, a housing 1 rotatably supporting the rotor 3, a cover 9 covering an open end of the housing 1, and an angle detection member (output detection member) that is accommodated in the housing 1, operated by the revolution of the rotor 3, and constructed primarily of a slider assembly 10, a resistor pattern 4b and a collector pattern 4c. In FIG. 3, the resistor pattern 4b and the collector pattern 4c are not shown.

Referring to FIG. 1 through FIG. 4, the housing 1 is made of a synthetic resin material, such as polybutylene terephthalate (PBT), and formed by molding. The housing 1 has a small-diameter hole 1a provided in one end surface thereof, a large-diameter recessed portion 1b provided consecutively to the small-diameter hole 1a, an accommodating portion 1c provided consecutively to the large-diameter recessed portion 1b, and a lead-out portion 1e projecting outward in the direction orthogonal with respect to the axis of a part of a side wall 1d of the large-diameter recessed portion 1b.

Under the accommodating portion 1c in the drawing, that is, in the other end surface of the housing 1, an open end portion 1f is formed. Thus, the housing 1 has free ends, one end surface having the small-diameter hole 1a and the other end surface having the open end portion 1f.

The distal end surface adjacent to the open end portion 1f is provided with an annular groove 1m.

The small-diameter hole 1a is equipped with an annular jaw 1g jutting out inward at a predetermined location, an annular stepped portion 1h provided at the distal end, and a pair of opposing protuberances 1j provided on the distal end surface.

The lead-out portion 1e has a substantially rectangular hollow portion 1k substantially at the center thereof.

A lead-out terminal 2 is formed of an electrically conductive metal material, such as brass, and formed by press working. The section of the lead-out terminal 2 has a stepped configuration and is formed of an internal pin 2a on one end thereof, an external pin 2b on the other end thereof and a connecting portion 2c for connecting the internal pin 2a and the external pin 2b.

The lead-out terminal 2 is provided in the lead-out portion 1e of the housing 1 by insert molding so as to be formed into one piece. The lead-out terminal 2 is formed to be relatively thick with a predetermined dimension.

At this time, the internal pin 2a of the lead-out terminal 2 is disposed with one surface thereof exposed in the accommodating portion 1c of the housing 1, while the external pin 2b is disposed such that it juts out in the hollow portion 1k.

The rotor 3 is made of a synthetic resin material, such as polybutylene terephthalate (PBT), and formed by molding. The rotor 3 has a substantially discoid base 3a, an engaging portion 3b that is positioned before the base 3a and protrudes, a shaft 3c that is positioned at the opposite rear side, provided at the rotative center of the rotor 3 and extended in the direction of the rotative axis, i.e., outward, and a substantially annular wall 3d provided on the outer periphery of the base 3a. The engaging portion 3b and the shaft 3c are provided such that they jut outward from the base 3a.

The shaft 3c protrudes from the base 3a in the direction of the rotative axis, i.e., outward, and has a columnar main shaft 3e and a substantially conical shaft support 3f provided as a protuberant portion at the distal end of the main shaft 3e. The shaft support 3f is shaped so as to have a section of a predetermined angle (e.g., about 90 degrees). This predetermined angle is (e.g., 90 degrees) decided to permit easy machining.

The diameter of the outer periphery of the engaging portion 3b is set to be slightly smaller than that of the small-diameter hole 1a so as to secure a space that allows the rotor 3 to incline.

A driving shaft (not shown) is engaged with the engaging portion 3b. The driving shaft is adapted to rotate in a reciprocating motion within a predetermined range of rotational angle.

The engaging portion 3b of the rotor 3 is inserted into the small-diameter hole 1a of the housing 1, while the base 3a of the rotor 3 is housed in the accommodating portion 1c of the housing 1.

Furthermore, the slider assembly 10 made of a metallic plate and formed by pressing is fixed by an appropriate means, such as heat swaging, below the bottom surface (adjacent to the shaft 3c) of the base 3a of the rotor 3, as shown in FIG. 1. The slider assembly 10 constitutes a part of a member making up the angle detection member or the output detection member.

As shown in FIG. 6, a resistor substrate 4 serving as the insulating board is made of, for example, a synthetic resin material. The resistor substrate 4 has a plate-shaped insulating base 4a, a resistor pattern 4b provided to be relatively thin by, for example, printing, on one surface of the insulating base 4a, a conductor pattern 4c, a through hole 4d provided substantially at the center of the insulating base 4a, and three rectangular mounting holes 4e (through holes) formed at the ends of the resistor pattern 4b on the insulating base 4a and the conductor pattern 4c. The resistor substrate 4 further has three rectangular first cuts 4f that oppose the mounting holes 4e and are provided in one end portion of the insulating base 4a, and a pair of rectangular second cuts 4g provided in opposing two ends of the insulating base 4a.

The resistor substrate 4 further includes three electrodes 4h that are provided at the lower side of the insulating base 4a, as shown in FIG. 6, electrically connected to the resistor pattern 4b and the conductor pattern 4c, and formed to be relatively thin. The middle one of electrodes 4h is connected to the conductor pattern 4c, and the electrodes 4h sandwiching the middle electrode 4h are, connected to both ends of the resistor pattern 4b.

The rectangular, mounting holes 4e are formed in the electrodes 4h, and the cuts 4f are formed at the distal ends of the electrodes 4h.

The resistor pattern 4b and the conductor pattern 4c are respectively formed like fans around the through hole 4d, the resistor pattern 4b being on the outer side and the conductor pattern 4c being on the inner side.

The resistor pattern. 4b and the conductor pattern 4c constitute a part of the member making up the angle detection member or the output detection member.

The resistor substrate 4 (insulating board) is placed on the stepped portion (not shown) provided on the edge, which is adjacent to the open end portion 1f, of the accommodating portion 1c of the housing 1, and retained by heat-swaging a part of the housing 1, then placed in the accommodating portion 1c. At this time, the distal end of the shaft 3c of the rotor 3 is fitted in the through hole 4d of the insulating base 4a of the resistor substrate 4, beyond one surface of the insulating base 4a.

The slider assembly 10 is disposed such that it can be brought in slidable contact with the resistor pattern 4b and the conductor pattern 4c of the resistor substrate 4.

Referring now to FIG. 9 through FIG. 11, an intermediate terminal 5 is made of an elastic conductive metal constituent and formed by pressing. The intermediate terminal 5 has a first contact portion 5a that is provided at the center and has an arcuate section, second contact portions 5b that are extended outward from both ends of the first contact portion 5a and bulged in the opposite direction from the first contact portion 5a and has an arcuate section, and a pair of mounting portions 5c extended at a predetermined acute angle from the ends of the second contact portions 5b.

The first contact portion 5a and the second contact portions 5b form a substantially undulate shape. In short, the intermediate terminal 5 has the pair of mounting portions 5c provided at both ends, the first contact portion 5a and the second contact portions 5b that are substantially undulate and provided between the paired mounting portions 5c.

To make the intermediate terminal 5 by pressing, it is punched out from the arcuate apex of the first contact portion 5a. The punching out sometimes produces small serrate edges known as burrs (not shown), which extend in the direction in which the mounting portions 5c extend, on both widthwise edges of the first and second contact portions 5a and 5b of the intermediate terminal 5.

As shown in FIG. 8, one mounting portion 5c of the intermediate terminal 5 is inserted in the mounting hole 4e of the resistor substrate 4, while the other mounting portion 5c is positioned in the first cut 4f. The intermediate terminal 5 is installed by the pair of mounting portions 5c provided at the acute angle such that it clamps the resistor substrate 4. At this time, the free ends of the pair of mounting portions 5c are positioned so that they do not jut outward beyond the back surface of the resistor substrate 4, the back surface opposing the surface on which the electrodes 4h are mounted.

In this state, the apexes of the pair of second contact portions 5b comes in resilient contact with the electrodes 4h to make electrical connection between the second contact portions 5b and the electrodes 4h. Since the apexes of the second contact portions 5b have very small burrs (not shown), as mentioned above, the burrs dig into the surface of the electrodes 4h so as to ensure further secure electrical and mechanical connection.

Similarly, in this state, the apex of the first contact portion 5a comes in resilient contact with the exposed surface of the internal pin 2a of the lead-out terminal 2 so as to make electrical connection between the first contact portion 5a and the lead-out terminal 2.

In other words, the electrodes 4h are electrically connected with the lead-out terminal 2 through the intermediate terminal 5.

Referring back to FIG. 3, a first elastic member 6 is made of a metal material, such as stainless steel, and formed by pressing. The first elastic member 6 is annular and has a plurality of (e.g., three) crests (not shown) and roots (not shown) that are alternately provided. The first elastic member 6 constitutes a “wave washer” or spring washer.

The first elastic member 6 is disposed on the base 3a of the rotor 3 and sandwiched between the base 3a and the small-diameter hole 1a of the housing 1. The first elastic member 6 applies pressure to the rotor 3 downward in FIG. 1.

As shown in FIGS. 3 and 4, a second elastic member 7 is a coil spring made of, for example, a spiral string metal constituent, and has U-shaped mounting portions 7a on its both ends.

The second elastic member 7 is mounted by its one mounting portion 7a installed in the large-diameter recessed portion 1b of the housing 1 by an appropriate means, and the other mounting portion 7a installed on the base 3a of the rotor 3 by an appropriate means while the second elastic member 7 being in a flexed state.

In this state, the rotor 3 is rotatively urged clockwise or counterclockwise by the torque or twisting force of the second elastic member 7.

A third elastic member 8 is made of, for example, a rubber constituent, and formed into an approximately annular shape, and constructed of an arcuate portion 8a and a U-shaped portion 8b extending from the arcuate portion 8a, as shown in FIGS. 3 and 4.

The third elastic member 8 is press-fitted into the groove 1m of the housing 1.

Referring to FIGS. 3 and 4, a cover 9 is made of a metal plate constituent and formed by pressing. The cover 9 has a substantially plate-shaped covering portion 9a, a conical first recessed portion 9b provided substantially at the center of the covering portion 9a, a second rectangular recessed portion 9c provided at a predetermined end of the covering portion 9a, and a plurality of (e.g., four) notches 9d provided at predetermined locations of the outer periphery of the covering portion 9a.

The first recessed portion 9b is formed by ejecting with, for example, a conical punching metal mold so as to have a section of a predetermined angle (e.g., about 94 degrees).

When the punching metal mold is used for the ejecting work, the punching metal mold is abutted against the inner surface of the recessed portion, whereas the jutting side is not abutted against the metal mold. This allows the conical inner surface of the recessed portion 9b to be formed into a predetermined shape with high accuracy.

The cover 9 is disposed to hermetically close the free end portion 1f of the housing 1, as shown in FIG. 1. To hermetically close the free end portion 1f by the cover 9, mounting portions 1n formed on the outer periphery of the free end portion 1f are positioned in the notches 9d of the cover 9, then the full periphery of the free end portion 1f of the housing 1 is deformed by heat swaging or the like from the state shown in FIG. 1. The cover 9 is installed to the housing 1 by the deformed mounting portions 1n.

In the aforesaid state, the third elastic member 8, which has been press-fitted in the groove 1m of the housing 1 is abutted in an elastically deformed state against one surface in the vicinity of the outer periphery of the cover 9. The elastically deformed third elastic member 8 in contact under pressure hermetically closes the free end portion 1f by the cover 9.

In this state, a substantially conical shaft support 3f of the shaft 3c that is provided at the rotative center of the rotor 3 is disposed in the first recessed portion 9b of the cover 9, as shown in FIG. 5. The shaft support 3f disposed in the first recessed portion 9b allows the rotor 3 to rotated about the shaft 3c.

The angle of the section of the first recessed portion 9b is set at a predetermined angle (e.g., about 94 degrees) that is slightly larger than the angle of the section of the substantially conical shaft support 3f, so that the shaft support 3f can be slightly inclined in the first recessed portion 9b. This means that the first recessed portion 9b and the shaft support 3f constitute a pivotal mechanism.

Accordingly, even if the drive shaft is eccentrically installed to the engaging portion 3b, the relative dislocation of the slider assembly 10 in relation to the resistor pattern 4b can be restrained, as compared with the case where the rotor 3 moves in parallel.

In this state, as shown in FIG. 1, a pair of mounting portions 5c of the intermediate terminal 5 is disposed at the position opposing the second recessed portion 9c of the cover 9. The second recessed portion 9c provides further secure electrical isolation or non-conduction between the cover 9 made of a metal material and the pair of mounting portions 5c of the intermediate terminal 5.

Referring to FIGS. 3 and 4, the slider assembly 10 is formed of an elastic metal material, such as phosphor bronze, and formed by pressing. The slider assembly 10 has a substantially rectangular base portion 10a, a plurality of sliders 10b extended from an end of the base portion 10a and an insertion hole 10c provided at a predetermined location of the base portion 10a.

The slider assembly 10 is secured to a predetermined location of the base 3a of the rotor 3 by an appropriate means, such as heat swaging. The plurality of sliders 10b is disposed such that it slides on the resistor pattern 4b and the conductor pattern 4c of the resistor substrate 4. At this time, the shaft 3c of the rotor 3 is inserted in the insertion hole 10c.

A fourth elastic member 11 is made of, for example, a rubber constituent, and formed into an approximately annular shape. The fourth elastic member 11 is rested on an annular jaw 1g of the housing 1. The outer periphery of the fourth elastic member 11 is in resilient contact in the small-diameter hole 1a, and the inner periphery of the fourth elastic member 11 is in resilient contact with the engaging portion 3b of the rotor 3.

In short, the fourth elastic member 11 is resiliently disposed between the housing 1 and the rotor 3 to hermetically close the gap between the housing 1 and the rotor 3.

A fifth elastic member 12 is made of, for example, a rubber constituent, and formed into an approximately annular shape. The fifth elastic member 12 is disposed on an annular stepped portion 1h of the housing 1, and in resilient contact with a side wall of the annular stepped portion 1h.

In this state, the outside diameter of the fifth elastic member 12 is slightly larger than the outside diameter of the annular stepped portion 1h.

Thus, the fifth elastic member 12 is disposed such that, when the engaging hole of a retaining member (not shown) of the drive shaft (not shown) of the throttle valve is press-fitted to the outer periphery of the fifth elastic member 12, although it is not shown, the fifth elastic member 12 is pressed into contact with the engaging hole of the retaining member (not shown) so as to prevent dust or water from entering.

A stopper 13 is made of a metal plate constituent and formed by pressing. The stopper 13 has an annular stopping portion 13a and a pair of through holes 13b provided at predetermined locations of the stopping portion 13a, the through holes 13b opposing each other.

To fix the stopper 13, the pair of protuberances 1j of the housing 1 is inserted in the pair of through holes 13b and secured to the distal end surface of the small-diameter hole 1a by, for example, heat swaging.

The secured stopper 13 prevents the fifth elastic member 12 from coming off the housing 1.

In this state, the outside diameter of the stopper 13 is set to be slightly smaller than the outside diameter of the fifth elastic member 12. This makes it possible to dispose the stopper 13 in the engaging hole of a retaining member (not shown) of the drive shaft (not shown) of the throttle valve.

In the embodiment described above, the shaft 3c of the rotor 3, which is a projection, is formed to have a predetermined angle (e.g., about 90 degrees), and the recessed portion 9c of the cover 9 is formed to have a predetermined angle (e.g., about 94 degrees) that is slightly larger than the angle of the shaft 3c. These angles, however, are not limited to the foregoing values; they may of course be set to substantially the same angle or the respective angles may be set to different angles from the above.

The operation of the rotary sensor in accordance with the present invention will now be described.

As previously mentioned, the rotary sensor in accordance with the present invention is operated by engaging a drive shaft, such as a vehicular throttle shaft (not shown) with the engaging portion 3b of the rotor 3.

First, when the drive shaft, such as a throttle shaft, (not shown), is rotated counterclockwise, the engaging portion 3b engaged with the drive shaft rotates counterclockwise against the torque or twisting force of the second elastic member 7.

As the engaging portion 3b of the rotor 3 rotates, the slider assembly 10 secured to the base 3a of the rotor 3 rotates counterclockwise within a predetermined range of rotational angle. At this time, the slider assembly 10 slides on the resistor pattern 4b and the conductor pattern 4c of the resistor substrate 4, and a predetermined resistance value from the resistor pattern 4b is output from the lead-out terminal 2 via the intermediate terminal 5.

Then, when the torque for rotating the drive shaft (not shown) counterclockwise is cleared, the torque or twisting force for self-resetting of the second elastic member 7 causes the rotor 3 to rotate clockwise so as to reset the drive shaft (not shown) at its home position. In this case also, a predetermined resistance value from the resistor pattern 4b is output from the lead-out terminal 2 via the intermediate terminal 5.

The descriptions will now be given of the expansion and contraction of the housing, the lead-out terminal, the resistor substrate, the intermediate terminal and others making up the rotary sensor caused by changes in the operating temperature of the rotary sensor.

First, the descriptions will be given of the state wherein a drive engine (not shown) becomes hot due to the combustion of the gasoline in a combustion chamber when a vehicle (not shown) with the rotary sensor installed therein has been started up, leading to a rise in the temperature of the rotary sensor.

When the rotary sensor becomes hot, the housing 1, the lead-out terminal 2, the resistor substrate 4, the intermediate terminal 5 and other components making up the rotary sensor expand due to the rise in temperature. The degrees of the expansion of the components usually differ, depending upon their individual expansion coefficients. The thermal expansion of the housing 1, the intermediate terminal 5 and the lead-out terminal 2 under the foregoing condition will be explained.

The intermediate terminal 5 and the lead-out terminal 2 formed of a metal material have such a small degree of thermal expansion that can be ignored, as compared with the housing 1 formed of a synthetic resin. The question, therefore, is the deformation of the housing 1. Furthermore, a synthetic resin constituent exists between the part of the housing 1 where the resistor substrate 4 is retained and the part where the internal pin 2a is retained. The part retaining the internal pin 2a is roughly positioned on the inner bottom surface of the accommodating portion 1c, while the part of the housing 1 that retains the resistor substrate 4 is roughly positioned at the side wall of the accommodating portion 1c.

A change in the temperature causes a three-dimensional change in the positions of the above two components. In response to the displacement in the height direction in FIG. 1, the arcuate portion of the first contact portion 5a of the intermediate terminal 5 elastically deforms, maintaining the contact between the electrodes 4h and the second contact portions 5b and between the first contact portion 5a and the internal pin 2a. Relative displacement in the direction of the planes of the resistor substrate 4 causes the first contact portion 5a and the internal pin 2a to relatively shift while maintaining the contact between the second contact portions 5b and the electrodes 4h.

The positioning force for the resistor substrate 4 of the intermediate terminal 5 is set such that the mounting portions 5c shift in a direction to slightly expand with a resultant decrease in their clamping force because the arcuate portion of the first contact portion 5a is flexed toward the resistor substrate 4 when it is installed, whereas the secure positioning can be accomplished despite the slight decrease in the clamping force with consequent deteriorated positioning performance. The burrs add to the frictional force to prevent dislocation in the planar direction of the resistor substrate 4, thus maintaining the reliability of the contact between the electrodes 4h and the second contact portions 5b.

A second embodiment of a combination of the rotor and the cover for the rotary sensor in accordance with the present invention will now be described.

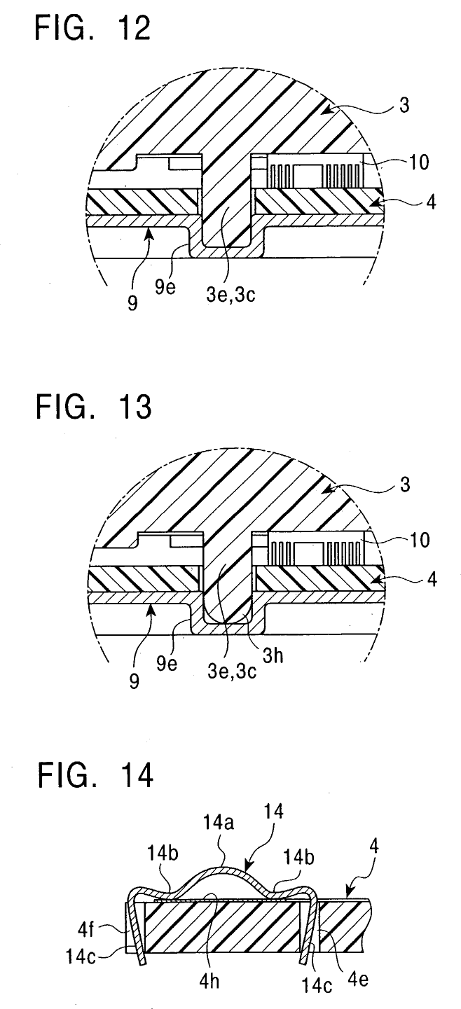

FIG. 12 is an enlarged sectional view of an essential section showing the second embodiment of the rotor and the cover for the rotary sensor in accordance with the present invention.

The like components as those in the first embodiment described above will be assigned the like reference numerals.

Referring to FIG. 12, a shaft 3c of a rotor 3 is provided at the rotative center of the rotor 3 and extended outward, or more specifically, downward in the axial direction. The entire shaft 3c has a columnar shape and is constructed only of a main shaft portion 3e with a flat distal end. The distal end of the main shaft portion 3e serves as a protuberant portion.

The distal end of the main shaft portion 3e is slightly chamfered. The columnar shape in combination with the flat distal end permits easier machining and the configuration that restrains the dislocation of the central axis or the rotative axis.

A first recessed portion 9e of a cover 9 is formed to have a cylindrical shape as a whole. The flat distal end of the columnar main shaft portion 3e, which serves as the protuberant portion, is inserted in the cylindrical first recessed portion 9e.

As previously mentioned, the main shaft portion 3e rotatively moves in the first recessed portion 9e.

A third embodiment of a combination of the rotor and the cover for the rotary sensor in accordance with the present invention will now be described.

FIG. 13 is an enlarged sectional view of an essential section showing the third embodiment of the rotor and the cover for the rotary sensor in accordance with the present invention.

The like components as those in the first embodiment described above will be assigned the like reference numerals.

Referring to FIG. 13, a shaft 3c of a rotor 3 is provided at the rotative center of the rotor 3 and extended outward, or more specifically, downward in the axial direction. The entire shaft 3c has a columnar main shaft portion 3e and a hemispheric shaft support 3h provided at the distal end of the main shaft portion 3e and provided as a protuberant portion. In other words, the hemispheric shaft support 3h serves as the protuberant portion.

The first recessed portion 9e of the cover 9 is formed to be cylindrical, as a whole. The hemispheric shaft support 3h serving as the protuberant portion is inserted in the cylindrical first recessed portion 9e.

As in the case of the above embodiment, the shaft support 3h of the shaft 3c rotatively moves in the first recessed portion 9e. With this arrangement, the rotor 3 smoothly rotates since the hemispheric configuration of the shaft support 3h reduces its abutting area in the first recessed portion 9e.

The operations of the second and third embodiments described above are the same as those of the above first embodiment, so that the explanation will not be repeated.

The descriptions will now be given of a second embodiment of the intermediate terminal for the rotary sensor in accordance with the present invention.

FIG. 14 is a sectional view of an essential section showing a second embodiment of the intermediate terminal for the rotary sensor in accordance with the present invention.

Referring to FIG. 14, an intermediate terminal 14 is made of an elastic conductive metal constituent and formed by pressing. The intermediate terminal 14 has a first contact portion 14a that is provided at the center and has an arcuate section, second contact portions 14b that are extended outward from both ends of the first contact portion 14a and bulged in the opposite direction from the first contact portion 14a and has an arcuate section, and a pair of mounting portions 14c extended at a predetermined acute angle from the ends of the second contact portions 14b. The first contact portion 14a and the second contact portions 14b form a substantially undulate shape.

As in the case of the intermediate terminal 5 in the first embodiment, both end surfaces of the first and second contact portions 14a and 14b of the intermediate terminal 14 sometimes have slightly serrate projecting edges known as burrs (not shown).

As shown in FIG. 14, one mounting portion 14c of the intermediate terminal 14 is inserted in a mounting hole 4e of a resistor substrate 4, while the other mounting portion 14c is positioned in a first cut 4f. The intermediate terminal 14 is installed by the pair of mounting portions 14c provided at the acute angle such that it clamps the resistor substrate 4. At this time, the free ends of the pair of mounting portions 14c are positioned so that they jut outward from the back surface of the resistor substrate 4.

In this state, the apexes of the pair of second contact portions 14b come in resilient contact with electrodes 4h to make electrical connection between the second contact portions 14b and the electrodes 4h. Since the apexes of the second contact portions 14b have very small burrs (not shown), as mentioned above, the burrs dig into the surface of the electrodes 4h so as to ensure further secure electrical and mechanical connection.

Furthermore, in this state, the apex of the first contact portion 14a is in resilient contact with the exposed surface of the internal pin 2a of the lead-out terminal 2 (refer to FIG. 1) so as to make electrical connection between the first contact portion 14a and the lead-out terminal 2.

In other words, the electrodes 4h are electrically connected with the lead-out terminal 2 through the intermediate terminal 14.

In this state, as shown in FIG. 1, the distal ends, which are free ends, of a pair of mounting portions 14c of the intermediate terminal 14 are disposed at the position opposing the second recessed portion 9c of the cover 9. The second recessed portion 9c provides further secure electrical isolation or non-conduction between the cover 9 made of a metal material and the pair of mounting portions 14c of the intermediate terminal 14.

Thus, according to this embodiment, the free ends of the pair of mounting portions 14c are disposed at the positions that project outward from the back surface of the resistor substrate 4. This arrangement makes it possible to further securely mount the intermediate terminal 14 to the resistor substrate 4, as compared with the installation of the intermediate terminal 5 onto the resistor substrate 4 in the first embodiment.

A third embodiment of the intermediate terminal for the rotary sensor in accordance with the present invention will now be described.

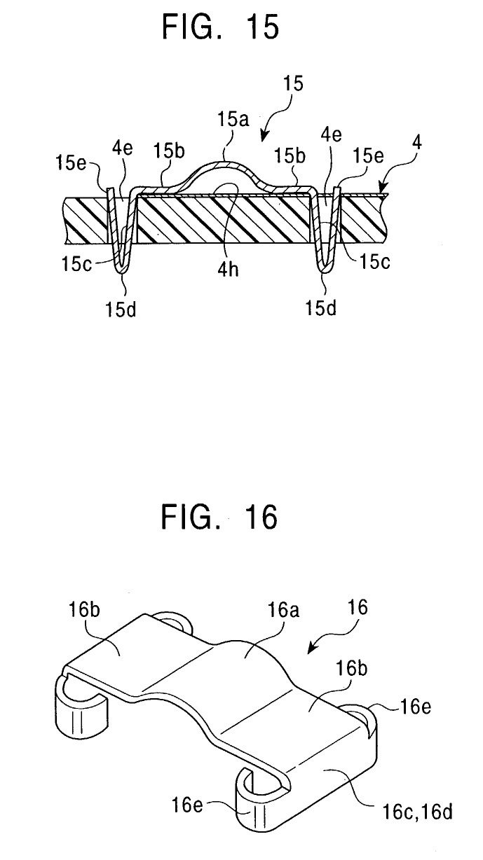

FIG. 15 is a sectional view of an essential section showing the third embodiment of the intermediate terminal for the rotary sensor in accordance with the present invention.

The like components as those in the first embodiment described above will be assigned the like reference numerals.

Referring to FIG. 15, an intermediate terminal 15 is made of an elastic conductive metal constituent and formed by pressing. The intermediate terminal 15 has a first contact portion 15a that is provided at the center and has an arcuate section, a pair of second contact portions 15b that is horizontally extended outward from both ends of the first contact portion 15a, a pair of first mounting portions 15c extended at a predetermined dull angle from the end of each of the second contact portions 15b, substantially U-shaped folded portions 15d at the ends of the first mounting portions 15c, and a pair of second mounting portions 15e extended upward from the folded portions 15d at a predetermined angle.

In short, the first mounting portions 15c, the folded portions 15d and the second mounting portions 15e constitute a springy mounting assembly having a substantially V-shaped section.

Unlike the embodiments described above, a resistor substrate 4 with which the intermediate terminal 15 is used has two through holes 4e at the positions where electrodes 4h are formed. The mounting portions formed of the first mounting portions 15c, the folded portions 15d and the second mounting portions 15e are inserted in the two through holes 4e, and the mounting portions are locked in the through holes 4e. In this state, the pair of second contact portions 15b horizontally extended are abutted against and rested on the electrodes 4h so as to establish electrical conduction between the intermediate terminals 15 and the electrodes 4h.

Furthermore, in this state, the folded portions 15d jut outward from the surface of the resistor substrate 4 that opposes the surface where the electrodes 4h are provided. As previously mentioned, the folded portions 15d of the intermediate terminal 15 that jut outward are positioned in the second recessed portion 9c of the cover 9. The second recessed portion 9c provides electrical isolation or non-conduction between the cover 9 and the folded portions 15d of the intermediate terminal 15 that are both formed of a metal material.

The first contact portion 15a of the intermediate terminal 15 is in resilient contact with the exposed surface of an internal pin 2a of a lead-out terminal 2, although it is not shown.

The springy mounting portion having the substantially V-shape allows the intermediate terminal 15 to be securely inserted with great ease in the two through holes 4e of the resistor substrate 4.

The intermediate terminal 15 is disposed by being pressed in contact with and between the internal pin 2a of the lead-out terminal 2 and the electrodes 4h of the resistor substrate 4.

The descriptions will now be given of a fourth embodiment of the intermediate terminal for the rotary sensor in accordance with the present invention.

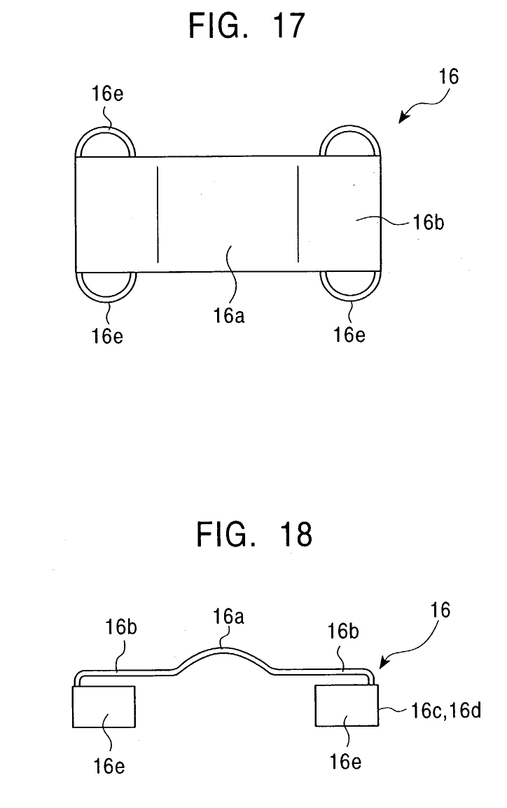

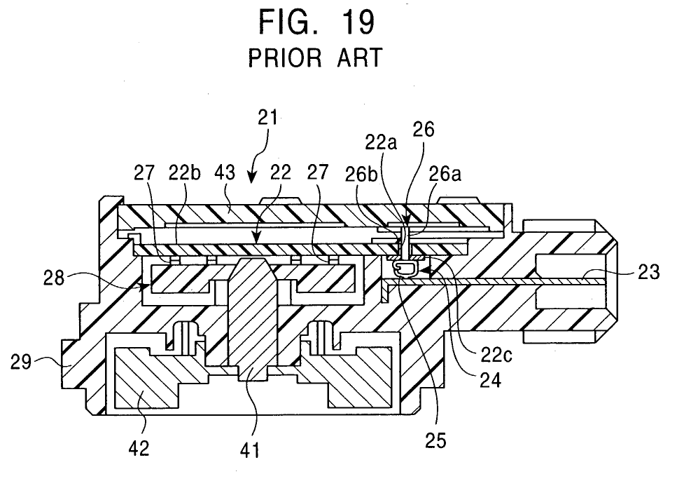

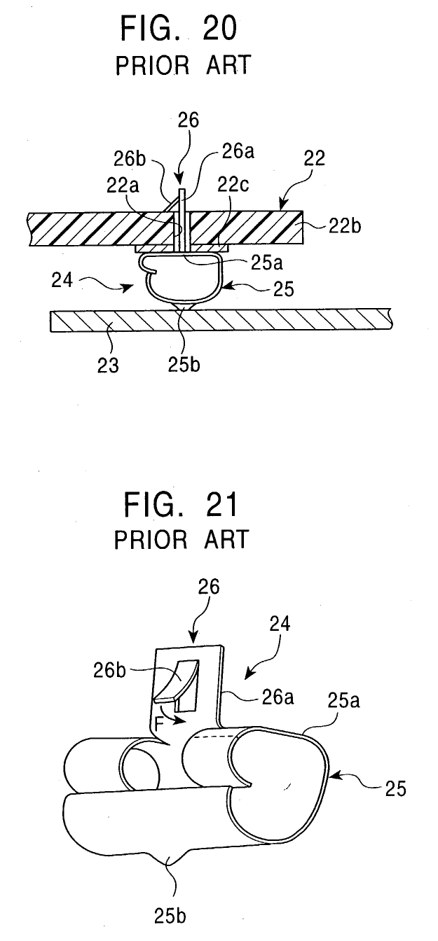

FIG. 16 is a perspective view showing the fourth embodiment of the intermediate terminal for the rotary sensor in accordance with the present invention, FIG. 17 is a top plan view showing the fourth embodiment of the intermediate terminal for the rotary sensor in accordance with the present invention, and FIG. 18 is a front view showing the fourth embodiment of the intermediate terminal for the rotary sensor in accordance with the present invention.

As shown in FIGS. 16 through 18, an intermediate terminal 16 is made of an elastic conductive metal constituent and formed by pressing. The intermediate terminal 16 has a pair of mounting portions 16c provided on both ends thereof, a first contact portion 16a that is provided at the center between a pair of mounting portions 16c and has an arcuate section, and a pair of second contact portions 16b horizontally extended from both ends of the first contact portion 16a.

The mounting portions 16c have retaining portions 16d perpendicularly extended downward from the second contact portions 16b, and semi-arcuate elastic portions 16e extended outward from the opposing side ends of the retaining portions 16d.

The intermediate terminal 16 is installed in the two through holes 4e of the resistor substrate 4 (refer to FIG. 15) by the substantially similar mounting method as that for the intermediate terminal 15 in the third embodiment described above. The intermediate terminal 16 is securely fixed to the resistor substrate 4 by the elastic force of the elastic portions 16e of the mounting portions 16c.

In this state, the pair of second contact portions 16b horizontally extended are abutted against and rested on the electrodes 4h (refer to FIG. 15) so as to establish electrical conduction between the intermediate terminals 16 and the electrodes 4h.

Although not shown, the first contact portions 16a of the intermediate terminal 16 is in resilient contact with the exposed surface of the internal pin 2a of the lead-out terminal 2.

To make the intermediate terminals 14, 15 and 16 in the aforesaid second, third and fourth embodiments by pressing, they are punched out from the arcuate apex of the first contact portion, as in the case of the intermediate terminal 5 in the first embodiment.

In the embodiments-described above, the electrodes on the resistor substrate have through holes and notches; however, the present invention is not limited thereto. Alternatively, recessed portions may be provided in the electrodes and the mounting portions of the intermediate terminal may be locked in the recessed portions.

In the aforesaid embodiments, the angle detection member constructed of the variable resistor that includes the slider assembly 10, the resistor pattern 4b and the collector pattern 4c is used to detect rotational angles; however, the present invention is not limited thereto. As an alternative, an output detector, such as an encoder, formed of a slider assembly and a conductive pattern shaped like comb teeth for detecting or outputting rotational speeds, rotational directions or the like may be used.

In the foregoing embodiments, the shaft support 3f of the shaft 3c of the rotor 3 is formed to be protuberant, and the recessed portion 9c for receiving the shaft support 3f of the shaft 3c, which is protuberant, is provided in the cover 9; however, the present invention is not limited thereto. Alternatively, the distal end of the shaft 3c of the rotor 3 may be formed to be recessed and the cover may be provided with a protuberant portion.

The intermediate terminals of the first through fourth embodiments are positioned in the direction of the plate surfaces with respect to the resistor substrates 4 by retaining the mounting portions 5c or the like in the mounting holes 4e of the resistor substrate 4 or the first notches 4f. Alternatively, however, the mounting portions may be omitted, and the burrs produced when machining the intermediate terminals may be dug into the electrode patterns to retain the intermediate terminals in the planar direction of the resistor substrate 4, or protuberances may be formed to dig them into the electrodes. In short, other means may be used as long as the force for retaining the intermediate terminal on the electrode is larger than the frictional force of the internal pin 2a of the intermediate terminal with respect to the insulating board.

What is claimed is:

1. A rotary sensor comprising:
a housing;
a lead-out terminal that is made integral with the housing and comprises an internal terminal and an external terminal;
an output detection member accommodated in the housing; and
an intermediate terminal for electrically connecting the lead-out terminal and the output detection member,
wherein the output detection member is formed of an insulating board having an electrode on its surface, a retaining portion being formed on the insulating board,
the intermediate terminal is formed of a single sheet of elastic metal constituent, and has a pair of mounting portions provided on both ends thereof and a first contact portion and a second contact portion provided between the pair of mounting portions,
the intermediate terminal is secured to the retaining portion by the pair of mounting portions such that it sandwiches the insulating board in the direction of its surfaces,
the output detection member with the intermediate terminal secured thereto is accommodated in the housing, and
the first contact portion is in resilient contact with the internal terminal and the second contact portion is in resilient contact with the electrode.

2. The rotary sensor according to claim 1, wherein the intermediate terminal has an arcuate first contact portion provided at the center thereof and a pair of second contact portions provided on both sides of the first contact portion.

3. The rotary sensor according to claim 1, wherein the retaining portion of the insulating board is a through hole, and the mounting portion of the intermediate terminal is locked in the through hole.

4. The rotary sensor according to claim 1, wherein a free end of the mounting portion of the intermediate terminal does not protrude outward beyond the surface opposing the surface on which the electrode of the insulating board has been provided.

5. The rotary sensor according to claim 1, wherein the output detection member detects a rotational angle.

6. A rotary sensor comprising:
a housing;
a lead-out terminal that is made integral with the housing and comprises an internal terminal and an external terminal;
an output detection member accommodated in the housing; and
an intermediate terminal for electrically connecting the lead-out terminal and the output detection member,
wherein the output detection member is formed of an insulating board having an electrode on its surface,
the intermediate terminal is formed of a single sheet of elastic metal constituent, and has a first contact portion, a second contact portion, and a projection that is provided on the second contact portion and bites into the electrode,
the output detection member with the intermediate terminal secured to the electrode by the projection of the intermediate terminal is accommodated in the housing, and
the first contact portion is in resilient contact with the internal terminal, while the second contact portion is in resilient contact with the electrode.

7. The rotary sensor according to claim 6, wherein the intermediate terminal has an arcuate first contact portion provided at the center thereof and a pair of second contact portions provided on both sides of the first contact portion, and at least one of the second contact portions is provided with a projection biting into the electrode.
